(19) United States
(12) Patent Application Publication
(10) Pub. No.: US 2005/0177608 A1
(43) Pub. Date: Aug. 11, 2005

(54) Fast Fourier transform processor and method using half-sized memory

(75) Inventor: Jung-joo Lee, Seoul (KR)

Correspondence Address: MILLS & ONELLO LLP, ELEVEN BEACON STREET, SUITE 605, BOSTON, MA, 02108, US

(73) Assignee: Samsung Electronics Co., Ltd.

(21) Appl. No.: 11/036,242

(22) Filed: Jan. 14, 2005

(30) Foreign Application Priority Data
Feb. 11, 2004 (KR) 04-8925

(51) Int. Cl. G06F 15/00

(52) U.S. Cl. 708/404

(57) ABSTRACT

In a fast Fourier transform processor and a fast Fourier transform method using half-sized memories, a butterfly computational element is utilized and one write operation and one read operation are performed during one clock cycle, assuming a virtual memory space at each of two memory units can accommodate N/2 points of data.

### BACKGROUND OF THE INVENTION

This application claims the benefit of Korean Patent Application No. 2004-8925, filed on Feb. 11, 2004, in the Korean Intellectual Property Office, the disclosure of which is incorporated herein in its entirety by reference.

1. Field of the Invention

The present invention relates to a wired/wireless communication system, and more particularly, to a fast Fourier transform processor used to perform modulations or demodulations in transceivers for wired/wireless communications.

2. Description of the Related Art

Technologies and applications such as a transceiver for wireless LAN, asymmetric digital subscriber line (ADSL), very high-data rate digital subscriber line (VDSL), orthogonal frequency division multiplexing (OFDM), digital audio broadcasting (DAB), and multi-carrier modulation (MCM) systems require a processor capable of performing a fast Fourier transform. A fast Fourier transform algorithm decreases the number of computations performed by removing repeated calculations from a discrete Fourier transformation such as the transformation of Equation 1. In Equation 1, n indicates a time indices, k indicates frequency indices, and N indicates the number of points, or number of input data. Generally, a fast Fourier transform performed in a receiver transforms time domain signals into frequency domain signals. An inverse fast Fourier transform performed in a transmitter transforms frequency domain signals into time domain signals. In an inverse Fourier transformation, an inverse process of a fast Fourier transform is performed. A fast Fourier transform transforms a serially input data stream x(n) into parallel data of N points, and data X(k) transformed in parallel is modulated onto a sub-carrier and transferred, thereby increasing the data transfer rate.

$$K ( k ) = {\sum }_{n = 0}^{N - 1} x ( n ) {ⅇ}^{- j \frac{2 π}{N} {n}_{k}} , 0 \leq k \leq N - 1 \qquad Equation 1$$

In order to perform a fast Fourier transform, if an input data number m is used for a radix-m butterfly operation, the number of stages required for the FFT operation is equal to the value obtained by taking the logarithm to the base m of the total number of input data N, and an radix-m butterfly operations are performed a number of times at each stage. At each stage, as a result of performing a butterfly operation with m, m new data are stored in a different memory unit having the same addresses as the addresses of the input data. In a fast Fourier transform, a data alignment operation such as bit shuffling is commonly performed because properties of the time domain and the frequency domain are different. A butterfly operation is performed using data stored in a predetermined address of a memory, and the Bit Shuffling operation that stores data changed as a result of the butterfly operation is realized by complicated hardware. However, when a sequential design or pipelined design requiring complicated hardware is used, a delay commutator is difficult to realize due to the complicated hardware. A delay commutator is a unit that performs data alignment at each stage of the fast Fourier transform. When the number of input data is small, the delay commutator is realized by a shift register. When the number of the input data is large, the manufacturing cost and the size of the shift register increases. Thus, memory is used for this operation instead of a shift register. The configuration described above is an important factor determining the size of memory required in a hardware design.

Generally, in a butterfly operation, a radix-2 algorithm processes two input data to generate two new data. The radix-2 algorithm reads two data and writes two operation results to the same addresses of a different memory, repeatedly. In order to increase hardware utilization and to decrease the time required to perform an operation, at most two data read operations and two data write operations are performed at the same time. In order to realize at most four synchronous data operations by hardware, two dual-port memories consisting of a read-only memory and a write only memory are used for this purpose, or a pipelined architecture is used.

FIG. 1 is block diagram of a conventional fast Fourier transform processor 100 that employs two dual-port memories. Referring to FIG. 1, the fast Fourier transform processor 100 includes first and second memory units 110 and 120, each storing 16 points of data, and butterfly computational elements 130. FIG. 2 is a diagram for explaining a radix-2 algorithm of the fast Fourier transform processor 100 of FIG. 1. In FIG. 2, input data is assumed to be 16 points of data. Referring to FIGS. 1 and 2, in the conventional fast Fourier transform processor 100 using two dual-port memories storing 16 points of data, the read-only memory and write-only memory are separate at each stage of operation and perform at most four operations (two read operations and two write operations) at the same time. A data conflict does not occur because a read-only memory is changed into a write-only memory and vice versa to advance to a next stage of operation. For example, at a first stage of operation, the first memory unit 110 is used as a read-only memory and outputs 16 point input data, and the second memory unit 120 is a write-only memory storing the result of a radix-2 butterfly operation. At a second stage of operation, the second memory unit 120 is used as a read-only memory and outputs the result from the first operation stage, and the first memory unit 110 is changed into a write-only memory storing the result of a radix-2 butterfly operation using new coefficients. Since the read-only memory operates as a write-only memory at the next stage, and vice versa, a conflict between input data and output data does not occur, and only one computational element for butterfly operations is used. However, the memory required is of a size that is twice as large as the size of input data.

FIG. 3 is a block diagram of a conventional fast Fourier transform processor 300 having a pipelined architecture. Referring to FIG. 3, the fast Fourier transform processor 300 includes a first memory 410 storing 16 points of data, a second memory 420 storing 16/2 points of data, a third memory 430 storing 16/4 points of data, a fourth memory storing 16/8 points of data, a first butterfly computational element 411, a second butterfly computational element 421, a third butterfly computational element 431, a first delay commutator 412, a second delay commutator 422, and a third delay commutator 432. FIG. 4 is a diagram for explaining a radix-2 algorithm of the fast Fourier transform processor of FIG. 3. Referring to FIGS. 3 and 4, the fast Fourier transform processor 300 having the pipelined architecture uses a computational element for butterfly operation at each stage of operation, and the size of a memory and a delay commutator required at each stage of operation becomes progressively smaller. Referring to FIG. 4, memory domains 423, 433 to 435, and 443 to 449 are actually not required and are shared at the respective stages as are memory domains 420, 430, and 440. As described above, the domains are classified into a domain corresponding to an address performing the same operation at the same stage, and a computational element for a butterfly operation is repeatedly used at each stage in the conventional pipelined architecture. In the pipelined architecture, a next stage of butterfly operation of a data domain corresponding to an address having no data dependence between sequential stages can be initiated in a state in which operations of previous stages are not complete, thereby decreasing the time required for gaining a final transformation result FD. However, at each stage of operation, a computational element for a butterfly operation, a delay commutator, and memories N+N/2+N/4+N/8+ . . . are required, thereby increasing hardware costs.

As described above, in radix-m operations, the hardware costs for butterfly computational elements increase only in relation to the number of input data m required in butterfly operations, and the hardware costs for butterfly computational elements do not increase in relation to an increase of a point size N of input data. Since most of the hardware cost is incurred due to the cost of memories storing the result of each stage of operation, the costs are enormously increased when the point size N of input data is increased.

### SUMMARY OF THE INVENTION

The present invention provides a processor that performs a new fast Fourier transform algorithm in which a data array operation at each butterfly operation stage is transformed using a virtual address space in order to reduce the size of a memory used to perform the algorithm.

The present invention also provides a fast Fourier transform processing method in which a data array operation is performed using an optimized memory.

According to an aspect of the present invention, there is provided a fast Fourier transform processor including: a memory unit that receives N points of input data, stores the N points of input data, stores N points of butterfly operation results calculated using the input data at a first stage of operation, and stores N points of butterfly operation results calculated from stored butterfly operation results of a previous stage of operation, at each of a remainder of (logₘ N)−1 operation stages; and a butterfly computational element that performs a radix-m operation on the N points of data stored in the memory unit to generate the N points of butterfly operation results which are stored in the memory unit.

In one embodiment, the memory unit includes a first memory unit which stores N/2 points of data among the N points of data; and a second memory unit which stores the other N/2 points of data among the N points of data.

In another embodiment, the butterfly operation comprises, for example, a radix-2, radix-4, or radix-8 operation. The first memory unit and the second memory unit may comprise dual-port memory units.

In another embodiment, the butterfly computational element receives m/2 data from each of the first memory unit and the second memory unit to perform the radix-m operation, divides the radix-m operation results into m/2 data, and stores the radix-m operation result divided into m/2 data in each of the first memory unit and the second memory unit. The butterfly computational element simultaneously stores the radix-m operation results and receives m data that are to be used in a subsequent radix-m operation. The butterfly computational element stores the radix-m operation results at the addresses of data input before the synchronous operation. The butterfly computational element performs the radix-m operation during two or more cycles, performs the synchronous operation during one cycle, and performs a next radix-m operation during the synchronous operation using the data input prior to the synchronous operation.

According to another aspect of the present invention, there is provided a fast Fourier transform processing method including: receiving and storing N points of input data; storing N points of butterfly operation results calculated using the input data at a first operation stage among logₘ N operation stages; storing N points of butterfly operation results calculated from the stored result of a previous stage of operation at each of remaining (logₘ N)−1 operation stages; and performing a radix-m butterfly operation with the stored N points of data to generate the N points of butterfly operation results at each of the respective logₘ N operation stages.

In one embodiment, the operation of storing comprises: storing N/2 points of data among the N points of data in a first memory; and storing other N/2 points of data among the N points of data in a second memory. The radix of the operation may be, for example, radix-2, radix-4, or radix-8. The first memory unit and the second memory unit may comprise dual port memory units.

In another embodiment, generating the butterfly operation results comprises: performing the radix-m operation on m/2 data received from the first memory and m/2 data received from the second memory, dividing the radix-m operation results into m/2 data, and storing the radix-m operation results divided into m/2 data in the first memory unit and the second memory unit. Optionally, generating the butterfly operation results comprises simultaneously storing the radix-m operation results and receiving m data to be used in a subsequent radix-m operation. Additionally, generating the butterfly operation results optionally comprises storing the radix-m operation results at the addresses of data input before the synchronous operation. Generating the butterfly operation results further optionally comprises: performing the radix-m operation during two or more clock cycles, the synchronous operation being performed during one clock cycle, and performing a subsequent radix-m operation using the data input prior to the synchronous operation during the synchronous operation.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional fast Fourier transform processor using two dual-port memories;

FIG. 2 is a diagram for explaining a radix-2 algorithm of the fast Fourier transform processor of FIG. 1;

FIG. 3 is a block diagram of a conventional fast Fourier transform processor having a pipelined architecture;

FIG. 4 is a diagram for explaining a radix-2 algorithm of the fast Fourier transform processor of FIG. 3;

FIG. 5 is a block diagram of a fast Fourier transform processor according to an embodiment of the present invention;

FIG. 6 is a diagram for explaining a radix-2 algorithm of the fast Fourier transform processor of FIG. 5;

FIG. 7 is a block diagram of a butterfly computational element of FIG. 5;

FIG. 8 is a timing diagram for explaining the operation of the fast Fourier transform processor of FIG. 5; and

FIG. 9 is a diagram for explaining the operation of the memory unit of FIG. 5 in detail.

### DETAILED DESCRIPTION OF THE INVENTION

The attached drawings for illustrating preferred embodiments of the present invention are referred to in order to gain a sufficient understanding of the present invention, the merits thereof, and the objectives accomplished by the implementation of the present invention.

Hereinafter, the present invention will be described in detail by explaining preferred embodiments of the invention with reference to the attached drawings. Like reference numerals in the drawings denote like elements.

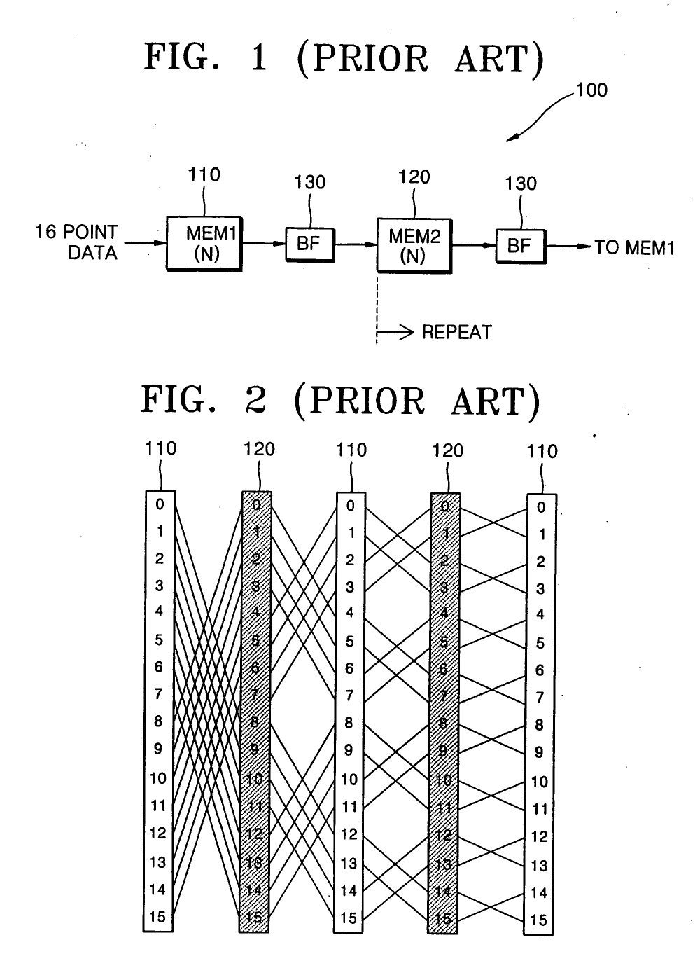

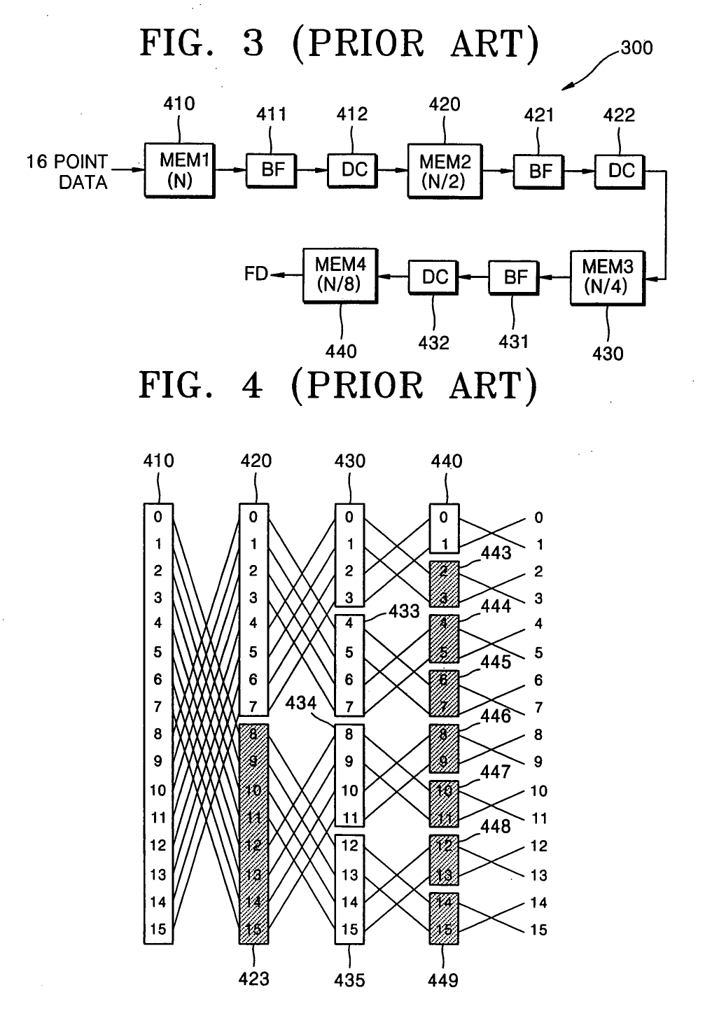

In a conventional fast Fourier transform processor 100 using two dual-port memories storing 16-point data as shown in FIG. 1, a memory unit operating as read-only memory is separate from a memory unit operating as a write-only memory, and the processor 100 performs at most two read operations and two write operations at the same time in a radix operation of a butterfly computational element 130. However, in a radix operation of each stage, a read-only memory and a write-only memory each of a size to accommodate the width of the data, namely 16 points, are required. Thus, an aspect of the present invention provides a new fast Fourier transform algorithm requiring only half the amount of memory. Two dual-port, half-sized memories, that is, memories that are half the size of the data width, are used, and a data array operation in a butterfly operation is transformed to operate as a pipelined architecture, thereby providing a new fast Fourier transform system and process in which only one butterfly computational element is required.

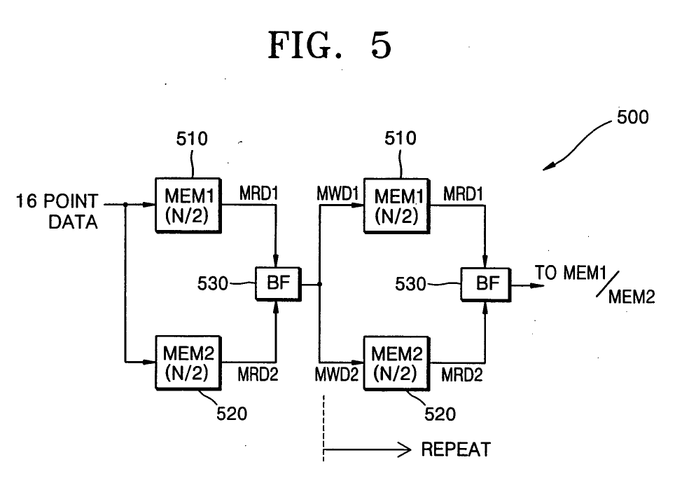

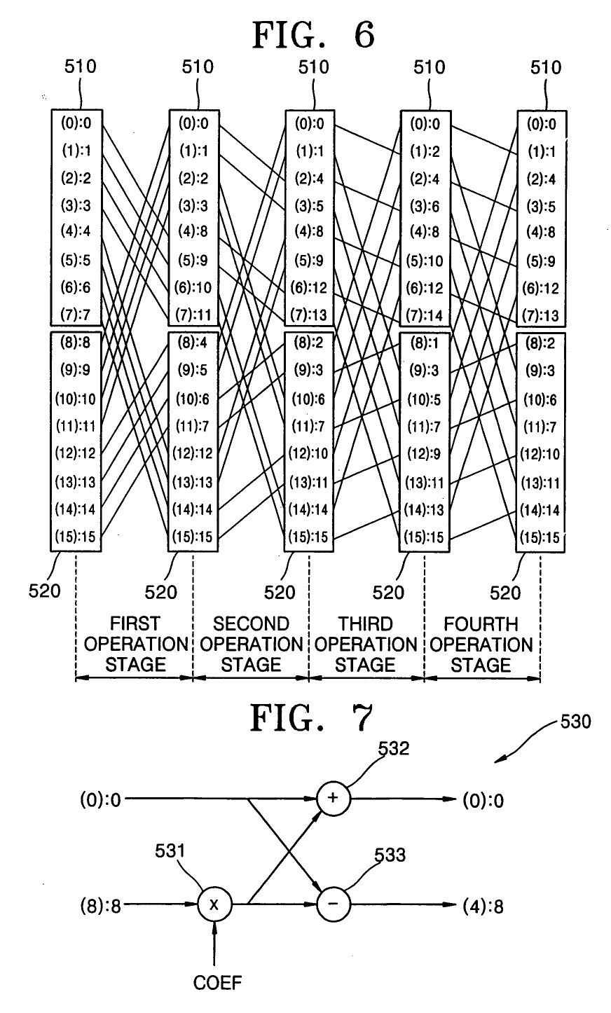

FIG. 5 is a block diagram of a fast Fourier transform processor according to an embodiment of the present invention. Referring to FIG. 5, a fast Fourier transform processor 500 includes two separate memory units 510 and 520, and a butterfly computational element 530. The memory units 510 and 520 include a first dual-port memory unit 510 and a second dual-port memory unit 520.

As is generally known, in a data array operation of a fast Fourier transform, if an input data number m is used for a radix-m butterfly operation, the number of stages required for the FFT operation is equal to the value obtained by taking the logarithm to the base m of the total number of input data N, namely, logₘ N. Hereinafter, it is assumed that the fast Fourier transform size N is 16, and the butterfly computational element 530 performs a radix-2 butterfly operation. However, the fast Fourier transform processor 500 according to an embodiment of the present invention is not restricted to the above, and the fast Fourier transform size N can be any number, for example, 256, 512, 1024, or 2048, depending on the size of the system. The butterfly computational element 530 performs not only the radix-2 butterfly operation, but also a radix-4, radix-8, etc., butterfly operations depending on the size of the system.

Under the assumption as described above, the first memory unit 510 stores N/2 (8), points of data of N (16) points of input data. The second memory unit 520 stores the other N/2 (8) points of data of (16) points of input data.

FIG. 6 is a diagram for explaining a radix-2 algorithm of the fast Fourier transform processor of FIG. 5.

Referring to FIG. 6, the first memory unit 510 and the second memory unit 520 each receive and store N/2 (8) points of a total of N (16) points of input data. Next, the memory units 510 and 520 store a butterfly operation result of N (16) points calculated by performing a first stage of operation on the input data. Next, from the second stage of operation to the (logₘ N)−1 operation stage (in this example, a fourth operation stage), at each stage of operation, the memory units 510 and 520 store the result of the butterfly operation of N (16) points, calculated from the stored result of a previous stage of operation. In this case, the first memory unit 510 and the second memory unit 520 do not operate as a read-only memory or a write-only memory at any given time. In a conventional dual-port memory process, a read-only memory and a write-only memory are shifted into each other. However, according to an embodiment of the present invention, referring to FIG. 6, a new memory read addressing process and a new memory write addressing process are used in order to avoid a data conflict.

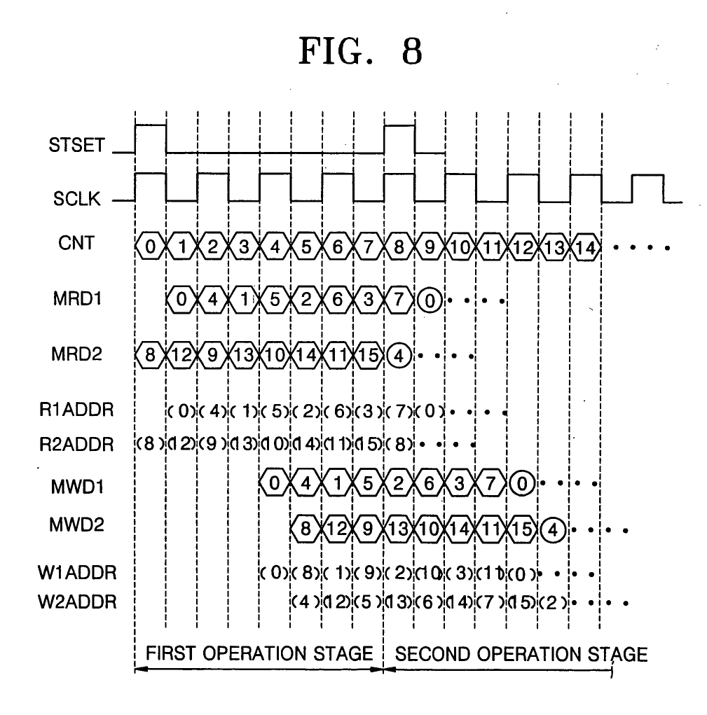

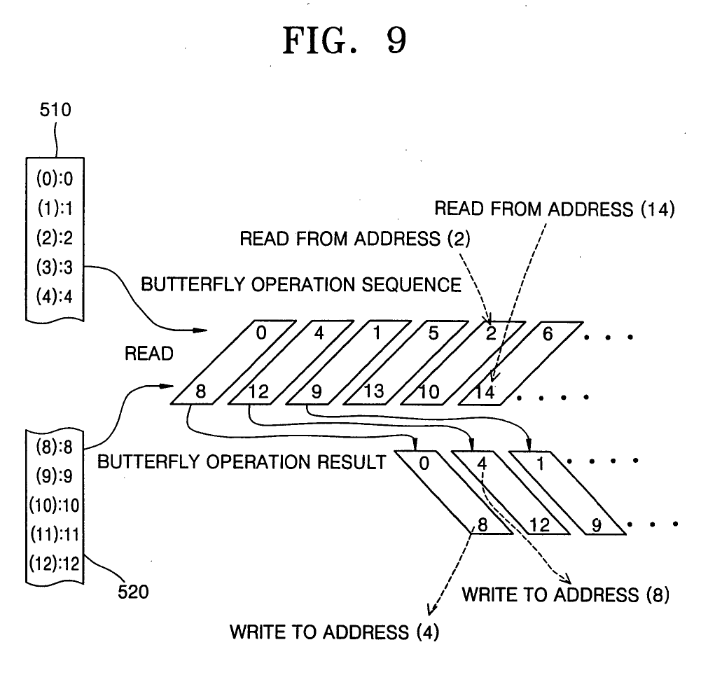

Usually, in a conventional architecture, at each stage of operation, for a radix-2 operation, the radix-2 butterfly operation results are stored in addresses of the write-only memory that are identical to addresses of data input from the read-only memory. Also, all data of the read-only memory is used in the radix-2 butterfly operation, the results of the radix-2 butterfly operation are stored in the write-only memory, the contents of the read-only memory are shifted to the write-only memory, and the contents of the write-only memory are shifted to the read-only memory. In contrast, in an embodiment of the present invention, the first memory unit 510 and the second memory unit 520 are not used as a read-only memory or a write-only memory and perform a read operation and a write operation simultaneously at each stage of operation. For example, referring to FIG. 2, at a first stage of operation, the result of a conventional radix-2 butterfly operation performed on data of an address (0) and data of an address (8) of the first memory unit 110 are stored as data of an address (8) and data of an address (0) of the second memory unit 120. However, referring to FIG. 6, in the present invention, at the first stage of operation, the results of performing the radix-2 butterfly operation on data of an address (0) of the first memory unit 510 and data of an address (8) of the second memory unit 520 are stored as data of an address (4) and data of an address (0) of the first memory unit 510. Also, referring to FIG. 6, in the present invention, at the first stage of operation, the results of performing the radix-2 butterfly operation on data of an address (4) of the first memory unit 510 and data of an address (12) of the second memory unit 520 are stored as data of an address (12) and data of an address (8) of the second memory unit 520. In this case, the first memory unit 510 and the second memory unit 520 do not perform two write operations at the same time, but a read operation and a write operation can be performed in one memory at the same time by performing addressing in a manner which pipelines the operation. The addressing process will be described in detail below with reference to FIGS. 8 and 9.

FIG. 7 is a block diagram of the butterfly computational element 530 of FIG. 5.

Referring to FIG. 7, the butterfly computational element 530 includes a multiplier 531, an adder 532, and a subtractor 533. Though the structure of the butterfly computational element 530 for the radix-2 operation is illustrated, the fast Fourier transform processor 500 according to an embodiment of the present invention can be applied to the structure of a butterfly computational element for a radix-4 operation or a radix-8 operation, or the like. The radix operations are performed 8 times at respective logₘ N (4) operation stages in order to obtain a discrete Fourier transformation result such as the result obtained by Equation 1, accordingly, the data array operation is completed through logₘ N (4) stages of operation. A discrete Fourier transformation and a radix operation are well described in general communication theories.

The butterfly computational element 530 performs a radix-m (2) operation for N (16) points of data stored in the memory units 510 and 520 at respective logₘ N (4) stages of operation. The results of an N (16) point butterfly operation calculated by the butterfly computational element 530 are stored in the memory units 510 and 520 again. At each stage, the butterfly computational element 530 receives data from the first memory unit 510 and the second memory unit 520 one by one and stores two operation results in the first memory unit 510 and the second memory unit 520 one by one. The butterfly operation is performed with N (16) input data at each stage, and is repeatedly performed 8 times in total. For example, referring to FIG. 7, a result obtained by performing a radix-2 butterfly operation on data “0” of an address (0) of the first memory unit 510 and data “8” of an address (8) of the second memory unit 520 using a predetermined coefficient COEF is data “0” of an address (0) and data “8” of an address (4) of the first memory unit 510 again following a predetermined number of cycles of a system clock. Here, for convenience of description, the result of a butterfly operation is assumed to have the same value as the value of input data. This is to say, data values “0” and “8”, input to the butterfly computational element 530, remain as values “0” and “8” again following operation. For the convenience of description, other input data values also produce results having the same values as the input data values. The input data described above and the results in the butterfly operation are shown in FIG. 6, and the whole relations are the same at each stage of operation.

FIG. 8 is a timing diagram for explaining the fast Fourier transform processor 500 of FIG. 5.

Referring to FIG. 8, it is assumed that an address generator (not shown) generates a first read address R1ADDR, a second read address R2ADDR, a first write address W1ADDR, and a second write address W2ADDR. The address generator refers to a count value CNT of a system clock SCLK and a stage setup signal STSET. The stage setup signal STSET is active at the beginning of each operation stage. The butterfly computational element 530 receives first input data MRD1 and second input data MRD2 from each of the first read address R1ADDR and the second address R2ADDR, respectively, and stores a first operation result MWD1 and a second operation result MWD2 in the first write address W1ADDR and the second write address W2ADDR, respectively, of the memory units 510 and 520, respectively.

Referring to FIGS. 6 and 8, first, at the first operation stage, data “8” of an address (8) of the second memory unit 520 and data “0” of an address (0) of the first memory are input to the butterfly computational element 530. Results obtained by performing the butterfly operation on the data “8” of the address (8) and the data “0” of the address (0) are generated during periods corresponding to the count values CNT “5” and “4” and are sequentially stored as data “8” of an address (4) and data “0” of an address (0) of the first memory unit 510. Next, data “12” of an address (12) of the second memory unit 520 and data “4” of an address (4) of the first memory unit 510 are sequentially input to the butterfly computational element 530. Results obtained by performing the butterfly operation on the data “12” of the address (12) and the data “4” of the address (4) are generated during periods corresponding to the count values CNT “6” and “5” and are stored as data “12” of an address (12) and data “4” of an address (8) of the second memory unit 520. Read and write operations of other data are well illustrated in FIG. 8.

In this case, since the first memory unit 510 and the second memory unit 520 are a dual-port type memory, two write operations cannot be performed at the same time. Accordingly, in order to prevent a data conflict from occurring between read operations of the memory units 510 and 520 and write operations of the memory units 510 and 520, according to an addressing process illustrated in FIG. 8, only one read operation and one write operation are performed at the same time within a single memory. For example, the first and the second input data MRD1 and MRD2 are “2” and “14” and the first and the second operation results MWD1 and MWD2 are “4” and “8” at the count value CNT “5”. Also, the first and the second read addresses R1ADDR and R2ADDR are (2) and (14), and the first and the second write addresses W1ADDR and W2ADDR are (8) and (4). Referring to FIG. 9, while the count value is CNT “5”, the first memory unit 510 reads “2” from the address (2) and writes “8” at the address (4). Also, while the count value CNT is “5”, the second memory unit 520 reads “14” from the address (14) and writes “4” to the address (8). The address generator generates addresses for preventing data conflict from occurring when the synchronous read and the write operations are performed in the memory units 510 and 520, referring to addresses corresponding to data already input to the butterfly computational element 530 from the memory units 510 and 520. The butterfly computational element 530 stores the radix-m (2) operation result at a data addresses already input before the synchronous read and the write operations in the memory units 510 and 520.

While the count value CNT is “6”, the first memory unit 510 reads data “6” from the address (6) and writes data “1” to the address (1). Also, at the moment of the count value CNT “6”, the second memory unit 520 reads data “11” from the address (11) and writes data “12” to the address (12). As described above, since one read operation and one write operation are synchronously performed during each count of the count value, in each of the first and second memory units 510 and 520, four memory accesses are possible at the same time using a memory that can accommodate 16 points of data. The operation as described above is the same as an operation of the second operation stage. For example, with reference again to FIG. 8, at the second stage of operation, first, data “4” of the address (8) of the second memory unit 520 and data “0” of the address (0) of the first memory are sequentially input to the butterfly computational element 530. Result of performing a butterfly operation on data “4” of the address (8) and data “0” of the address (0) are generated at the count values CNT “13” and “12” and are sequentially stored as data “4” of the address (2) and data “0” of the address (0). At the second operation stage, according to the same process as the process of the first operation stage, one read operation and one write operation are synchronously performed in each of the first memory unit 510 and the second memory unit 520.

As described above, the butterfly computational element 530 performing the radix-m (2) butterfly operation receives m/2 (1) data from each of the first memory unit 510 and the second memory unit 520 to perform the butterfly operation, divides the radix-2 operation result into m/2 (1) data, and stores the radix-2 operation results divided into m/2 (1) data in each of the first memory unit 510 and the second memory unit 520. Referring to FIG. 8, the radix-m (2) butterfly operation is performed during two or more cycles, and the synchronous operation which performs data reading from two memory units 510 and 520 and data writing to two memory units 510 and 520 at the same time is performed during one cycle. The butterfly computational element 530 performs a next radix-m operation among the synchronous read and write operations, using the data already input prior to the synchronous read and write operations.

On the other hand, when the butterfly computational element 530 performs a radix-4 or a radix-8 butterfly operation, the first memory unit 510 and the second memory unit 520 receive two or four data to perform the butterfly operation, divide the operation result into two or four data values, and store the operation results in each of the first memory unit 510 and the second memory unit 520. Also, each of the first memory unit 510 and the second memory unit 520 are partitioned into two or four dual type memories, and each divided memory performs one read operation and one write operation at the same time, thereby performing the same process. When the radix-m operation results are stored, the butterfly computational element 530 receives m data used in a next radix-m operation. Also, the butterfly computational element 530 stores the radix-m operation results at the addresses of the data already input before the read and write operations.

The numbers of transistors required when the fast Fourier transform algorithms according to an embodiment of the present invention and conventional algorithms are realized in hardware are compared to each other and are shown in Table 1. Table 1 includes certain data related to an example of realizing a 256-point fast Fourier transform processor used in an Asymmetric Digital Subscriber Line (ADSL) by the radix-2 process. In Table 1, about 10,000 gates are required in order to realize a butterfly computational element, and a gate includes 4 transistors in digital logic. Also, in a static random access memory (SRAM), about 6 transistors are required in order to realize a bit of memory. Accordingly, the entire hardware cost for realizing the 256-point fast Fourier transform processor is decreased more than 50% by the suggested method and structure of the present invention. A decrease in the number of butterfly computational elements and the size of memory can be achieved by conventional pipelining methods using algorithms such as radix-4 or radix-8, however, such decreases are not as great as the decrease achieved by the suggested method and structure of the present invention.

TABLE 1

| | conventional dual | conventional | |
|---|---|---|---|
| | port type | pipelined type | suggested type |
| number of butterfly | 1 | 8 | 1 |
| computational | | | |
| elements | | | |
| number of memory | 19,456 | 19,380 | 9,728 |
| bits | | | |
| total number of | 120,736 | 148,280 | 62,368 |
| transistors | | | |

As described above, the fast Fourier transform processor 500 according to an embodiment of the present invention performs data array operations at each butterfly operation stage, using the merits of the conventional dual-port memory structures and pipelined architectures. The fast Fourier transform processor 500 uses one butterfly computational element 530 and performs one write operation and one read operation during a clock cycle assuming there are virtual memory spaces in each of the two memory units 510 and 520 accommodating N/2-point data.

As described above, in the fast Fourier transform processor according to an embodiment of the present invention, the size of the memory units employed can be decreased by at least 50%, as compared to the conventional dual-port memory structure or the pipelined architecture using the two memory units accommodating N points of data. Also, one butterfly computational element is used in the present invention. Accordingly, there is an effect in which a fast Fourier transform process is realized using minimum hardware costs in systems that are sensitive to data delay times.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A fast Fourier transform processor comprising:
a memory unit that receives N points of input data, stores the N points of input data, stores N points of butterfly operation results calculated using the input data at a first stage of operation, and stores N points of butterfly operation results calculated from stored butterfly operation results of a previous stage of operation, at each of a remainder of (logₘ N)−1 operation stages; and
a butterfly computational element that performs a radix-m operation on the N points of data stored in the memory unit to generate the N points of butterfly operation results which are stored in the memory unit.

2. The processor of claim 1, wherein the memory comprises:
a first memory unit that stores N/2 points of data among the N points of data; and a second memory unit that stores the other N/2 points of data among the N points of data.

3. The processor of claim 1, wherein m is 2.

4. The processor of claim 1, wherein m is 4.

5. The processor of claim 1, wherein m is 8.

6. The processor of claim 2, wherein the first memory unit and the second memory unit are dual port memory units.

7. The processor of claim 2, wherein the butterfly computational element receives m/2 data from each of the first memory unit and the second memory unit to perform the radix-m operation, divides the radix-m operation results into m/2 data, and stores the radix-m operation results divided into m/2 data in each of the first memory unit and the second memory unit.

8. The processor of claim 7, wherein the butterfly computational element simultaneously stores the radix-m operation results and receives m data that are to be used in a subsequent radix-m operation.

9. The processor of claim 8, wherein the butterfly computational element stores the radix-m operation results at the addresses of data input before prior to the synchronous operation.

10. The processor of claim 8, wherein the butterfly computational element performs the radix-m operation during two or more cycles, performs the synchronous operation during one cycle, and performs a next radix-m operation during the synchronous operation using the data input prior to the synchronous operation.

11. A fast Fourier transform processing method comprising the operations of:
receiving and storing N points of input data;
storing N points of butterfly operation results calculated using the input data at a first operation stage among logₘ N operation stages;
storing N points of butterfly operation results calculated from the stored result of a previous stage of operation at each of remaining (logₘ N)−1 operation stages; and
performing a radix-m butterfly operation with the stored N points of data to generate the N points of butterfly operation results at each of the respective logₘ N operation stages.

12. The method of claim 11, wherein each of the operation of storing comprises:
storing N/2 points of data among the N points of data in a first memory unit; and
storing other N/2 points of data among the N points of data in a second memory unit.

13. The method of claim 11, wherein m is 2.

14. The method of claim 11, wherein m is 4.

15. The method of claim 11, wherein m is 8.

16. The method of claim 12, wherein the first memory unit and the second memory unit are dual port memory units.

17. The method of claim 12, wherein generating the butterfly operation results comprises: performing the radix-m operation on m/2 data received from the first memory and m/2 data received from the second memory, dividing the radix-m operation results into m/2 data, and storing the radix-m operation results divided into m/2 data in the first memory unit and the second memory unit.

18. The method of claim 17, wherein generating the butterfly operation results comprises simultaneously storing the radix-m operation results and receiving m data to be used in a subsequent radix-m operation.

19. The method of claim 18, wherein generating the butterfly operation results comprises storing the radix-m operation results at the addresses of data input before the synchronous operation.

20. The method of claim 18, wherein generating the butterfly operation results comprises: performing the radix-m operation during two or more clock cycles, the synchronous operation being performed during one clock cycle, and performing a subsequent radix-m operation using the data input prior to the synchronous operation during the synchronous operation.
